(19) United States
(12) Patent Application Publication
(10) Pub. No.: US 2012/0161446 A1
(43) Pub. Date: Jun. 28, 2012

(54) GLOBAL WIND FARM SURVEILLANCE SYSTEMS USING FIBER OPTIC SENSORS

(75) Inventors: Shanshan McNeill, Houston, TX (US); Garrett Moran, Houston, TX (US)

(73) Assignee: VESTAS WIND SYSTEMS A/S, Randers SV (DK)

(21) Appl. No.: 12/979,884

(22) Filed: Dec. 28, 2010

(51) Int. Cl. F03D 9/00; G01N 21/00; F01D 5/12; G01L 7/00; G01H 17/00; G01B 11/16; G01K 13/00

(52) U.S. Cl. 290/55; 356/32; 356/73.1; 374/141; 73/700; 73/570; 416/61; 374/E13.001

(57) ABSTRACT

Methods and apparatus for measuring a parameter (e.g., temperature, pressure, strain, or vibration) of at least a portion of a wind turbine generator using distributed sensing with optical fiber technology are provided. Fiber optic technology with distributed sensing offers a fast, low cost solution for measuring the parameter at myriad locations along substantial lengths of optical fiber. In this manner, the health or status of one or more components of the wind turbine generator may be monitored during or after the different stages of fabrication, transportation, site assembly, operation, and repair over time. Furthermore, data from multiple wind turbine generators may be sent to a local control station for processing and monitoring an entire wind farm in real time. Data from multiple wind farms may be transmitted from multiple local control stations to a remote station such that multiple wind farms may be monitored from a single location.

### BACKGROUND OF THE INVENTION

1. Field of the Invention

Embodiments of the invention generally relate to wind turbine generators and, more particularly, to monitoring one or more parameters of various components of a wind turbine generator using distributed sensing.

2. Description of the Related Art

As fossil fuels are being depleted, means for converting alternative energy sources are being researched and developed for more efficient ways to harness the power of the sun, flowing water, and the wind. Wind farms employing numerous wind turbine generators for converting wind energy to electrical energy are being located in areas of the world with consistent wind. In order to increase the efficiency of each wind turbine generator, the towers and the rotor blades have both been substantially increased in length, subjecting the components of the wind turbine generator to ever-increasing stresses, especially in areas with high winds. Furthermore, wind farms may be located in areas with freezing temperatures, where ice may form on the blades, further subjecting the components of the wind turbine generator to the possibility of mechanical failure.

### SUMMARY OF THE INVENTION

Embodiments of the invention generally relate to methods and apparatus for measuring a parameter of at least a portion of a wind turbine generator using distributed sensing.

One embodiment of the present invention provides a method of measuring a parameter of at least a portion of a wind turbine generator. The method generally includes emitting light into an optical fiber coupled to the at least the portion of the wind turbine generator, wherein the light is backscattered along the length of the optical fiber at a plurality of locations corresponding to different locations of the at least the portion of the wind turbine generator; receiving the backscattered light from the plurality of locations; and measuring the parameter at the corresponding locations of the at least the portion of the wind turbine generator based on the received backscattered light.

Another embodiment of the present invention provides a wind turbine generator. The wind turbine generator generally includes a tower; a nacelle coupled to the tower; a rotor coupled to the nacelle and having a hub and at least one blade coupled to the hub; an optical fiber coupled to at least one of the tower, the nacelle, or the blade and configured such that light emitted into an end of the optical fiber is backscattered along the length of the optical fiber at a plurality of locations corresponding to different locations of the tower, the nacelle, or the blade and is received at the end of the optical fiber from the plurality of locations; and at least one processor configured to measure a parameter of the at least one of the tower, the nacelle, or the blade at the corresponding locations based on the received backscattered light.

Yet another embodiment of the present invention provides a system. The system generally includes a plurality of wind turbine generators and a control station for receiving a measured parameter from the at least one of the wind turbine generators. At least one of the wind turbine generators generally includes a tower; a nacelle coupled to the tower; a rotor coupled to the nacelle and having a hub and at least one blade coupled to the hub; an optical fiber coupled to at least one of the tower, the nacelle, or the blade and configured such that light emitted into an end of the optical fiber is backscattered along the length of the optical fiber at a plurality of locations corresponding to different locations of the tower, the nacelle, or the blade and is received at the end of the optical fiber from the plurality of locations; and at least one processor configured to measure the parameter of the at least one of the tower, the nacelle, or the blade at the corresponding locations based on the received backscattered light.

Yet another embodiment of the invention provides a blade for a wind turbine generator. The blade typically includes a shell and an optical fiber coupled to or internal to the shell. The optical fiber is generally configured such that light emitted into an end of the optical fiber is backscattered along the length of the optical fiber at a plurality of locations corresponding to different locations of the blade and is received at the end of the optical fiber for measuring a parameter of the blade at the corresponding locations based on the received backscattered light.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary wind farm system, according to an embodiment of the invention.

FIG. 2 illustrates a diagrammatic view of an exemplary wind turbine generator, according to an embodiment of the invention.

FIG. 3 illustrates a diagrammatic view of the components internal to the nacelle and tower of a wind turbine generator, according to an embodiment of the invention.

FIG. 4 is a flow diagram of exemplary operations for measuring a parameter of at least a portion of a wind turbine generator using distributed sensing, according to an embodiment of the invention.

FIG. 5 illustrates a wind turbine blade with one or more optical fibers disposed flat-wise on an outer surface of the blade, according to an embodiment of the invention.

FIG. 6 illustrates a wind turbine blade with one or more optical fibers wrapped hoop-wise around the blade, according to an embodiment of the invention.

FIG. 7 illustrates a wind turbine blade with one or more optical fibers embedded diagonally in a shell of the blade, according to an embodiment of the invention.

FIG. 8 illustrates a wind turbine blade with one or more optical fibers wrapped around a spar of the blade, according to an embodiment of the invention.

FIGS. 9A and 9B illustrate a plurality of optical fibers routed from the root of a wind turbine blade for connection with a light emitter and an optical receiver in a hub of a rotor for a wind turbine generator, according to an embodiment of the invention.

FIG. 10 illustrates an optical fiber woven around bolts in a root of a wind turbine blade, according to an embodiment of the invention.

### DETAILED DESCRIPTION

Embodiments of the invention provide techniques and apparatus for measuring a parameter (e.g., temperature, pressure, strain, vibration, and the like) of at least a portion of a wind turbine generator using distributed sensing with optical fiber technology. Fiber optic technology with distributed sensing offers a fast, low cost solution for measuring the parameter at myriad locations along substantial lengths of optical fiber. In this manner, the health or status of one or more components of the wind turbine generator may be monitored during or after the different stages of fabrication, transportation, site assembly, operation, and repair over time. Furthermore, data from multiple wind turbine generators may be sent to a local control station for processing and monitoring an entire wind farm in real time. Data from multiple wind farms may be transmitted from multiple local control stations to a remote station such that multiple wind farms may be monitored from a single location. In this manner, embodiments of the present invention may function as an automated health monitoring system used for real time condition monitoring of wind turbine generators and/or their components, and control algorithms may be incorporated with the turbine controller to operate the wind turbine generator based on the monitoring measurements.

### An Example Wind Farm System

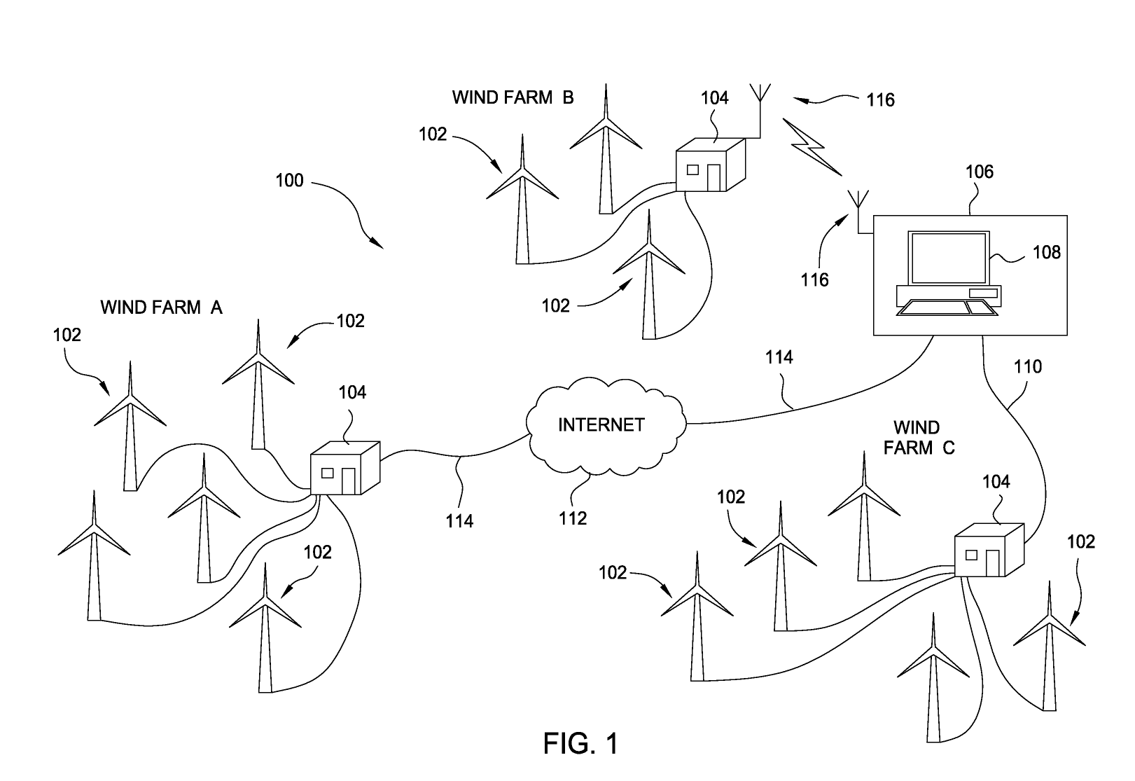

FIG. 1 illustrates an exemplary wind farm system 100 comprising multiple wind farms: Wind Farm A, Wind Farm B, and Wind Farm C, for example. Each wind farm in system 100 may comprise a plurality of wind turbine generators 102 for converting wind energy into electrical energy. Sensor and other data signals from—as well as control signals to—the wind turbine generators 102 may be transmitted wirelessly or via wires, cables, or any other suitable wired connections between a control station 104 and the wind turbine generators. The control station 104 is typically located on or near the corresponding wind farm.

Each of the (local) control stations 104 may communicate with a remote station 106 for monitoring multiple wind farms at a single location. Data from the control stations 104 may be processed by a computer 108, for example, and may be stored at the remote station 106. A computer or other processor located at each control station 104 may be used for real-time data analysis of the wind turbine generators 102, may compare this processed data with operating thresholds, and may generate a visual and/or audible alarm signal if an anomaly is detected. For example, when a parameter (e.g., temperature, pressure, strain, vibration, and the like) on a portion of one of the wind turbine generators 102 is determined to be outside a valid operating range, the control station may transmit a flag or other indication to the remote station 106.

For some embodiments, a control station 104 may be connected to the remote station 106 via a direct, hard-wired connection 110, such as a fiber optic cable. For other embodiments, a control station 104 may be connected to the remote station 106 via the Internet 112 using Ethernet cables 114, for example. For other embodiments, communication between a control station 104 and the remote station 106 may occur wirelessly using antennas 116 and any suitable wireless protocol, such as Long Term Evolution (LTE), EVDO (Evolution-Data Optimized), W-CDMA (Wideband Code Division Multiple Access), HSPA (High Speed Packet Access), GPRS (General Packet Radio Service), or EDGE (Enhanced Data rates for Global Evolution).

### An Example Wind Turbine Generator

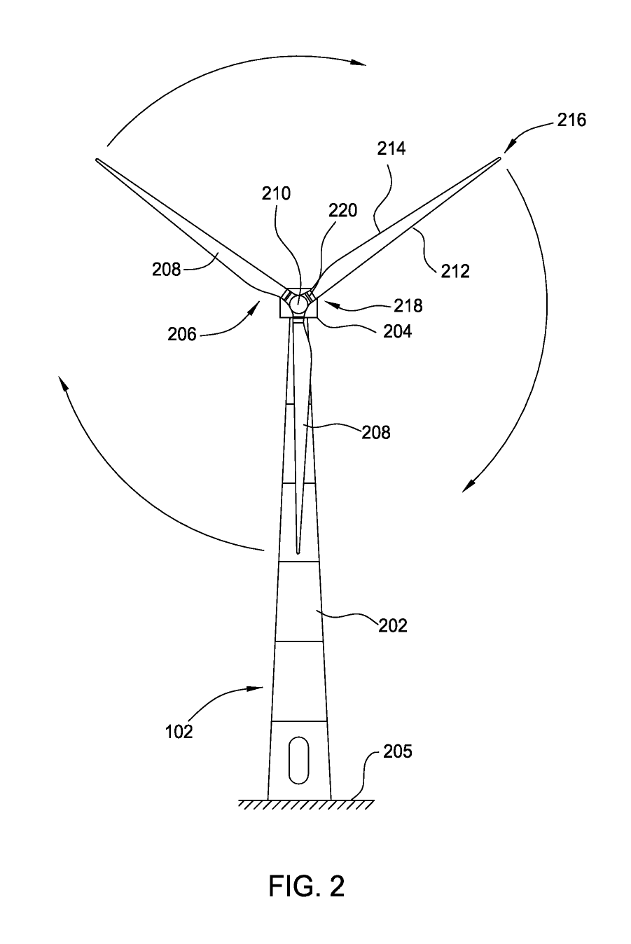

FIG. 2 illustrates a diagrammatic view of a horizontal-axis wind turbine generator 102. The wind turbine generator 102 typically comprises a tower 202 and a wind turbine nacelle 204 located at the top of the tower 202. The base of the tower 202 is typically mounted on a foundation 205. A wind turbine rotor 206 may be connected with the nacelle 204 through a low speed shaft extending out of the nacelle 204. As shown, the wind turbine rotor 206 comprises three rotor blades 208 mounted on a common hub 210, but may comprise any suitable number of blades, such as one, two, four, five, or more blades. As an airfoil driven by the force of the wind, the blade 208 typically has an aerodynamic shape with a leading edge 212 for facing into the wind, a trailing edge 214 at the opposite end of a chord for the blade 208, a tip 216, and a root 218 for attaching to the hub 210 in any suitable manner.

For some embodiments, the blades 208 may be connected with the hub 210 using pitch bearings 220 such that each blade 208 may be rotated around its longitudinal axis to adjust the blade's pitch. The pitch angle of a blade 208 may be controlled by linear actuators or stepper motors, for example, connected between the hub 210 and the blade.

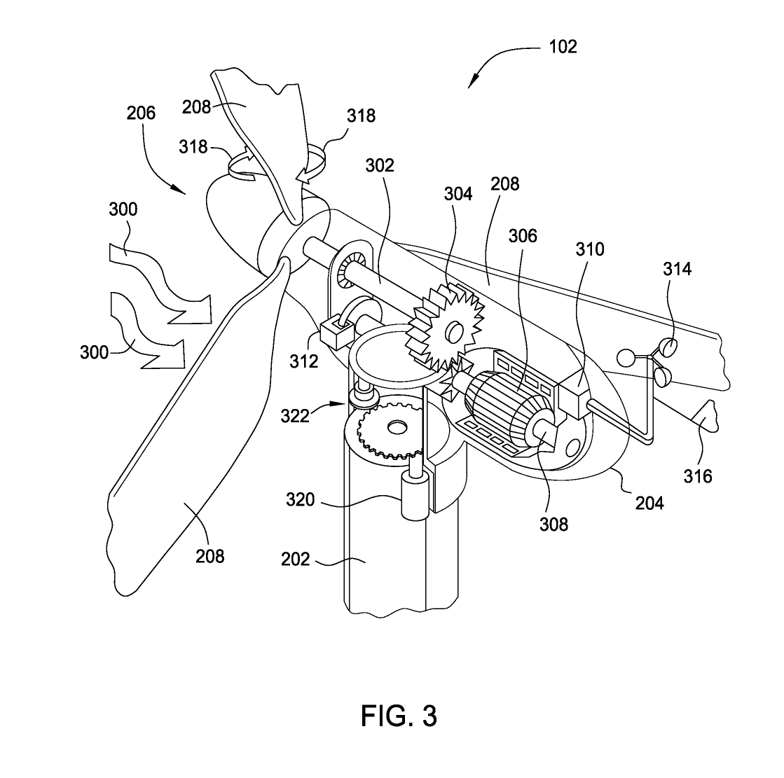

FIG. 3 illustrates a diagrammatic view of typical components internal to the nacelle 204 and tower 202 of a wind turbine generator 102. When the wind 300 pushes on the blades 208, the rotor 206 spins, thereby rotating a low-speed shaft 302. Gears in a gearbox 304 mechanically convert the low rotational speed of the low-speed shaft 302 into a relatively high rotational speed of a high-speed shaft 308 suitable for generating electricity using a generator 306.

A controller 310 may sense the rotational speed of one or both of the shafts 302, 308. If the controller decides that the shaft(s) are rotating too fast, the controller may signal a braking system 312 to slow the rotation of the shafts, which slows the rotation of the rotor 206, in turn. The braking system 312 may prevent damage to the components of the wind turbine generator 102. The controller 310 may also receive inputs from an anemometer 314 (providing wind speed) and/or a wind vane 316 (providing wind direction). Based on information received, the controller 310 may send a control signal to one or more of the blades 208 in an effort to adjust the pitch 318 of the blades. By adjusting the pitch 318 of the blades with respect to the wind direction, the rotational speed of the rotor (and therefore, the shafts 302, 308) may be increased or decreased. Based on the wind direction, for example, the controller 310 may send a control signal to an assembly comprising a yaw motor 320 and a yaw drive 322 to rotate the nacelle 204 with respect to the tower 202, such that the rotor 206 may be positioned to face more (or, in certain circumstances, less) upwind.

### Example Wind Farm Surveillance

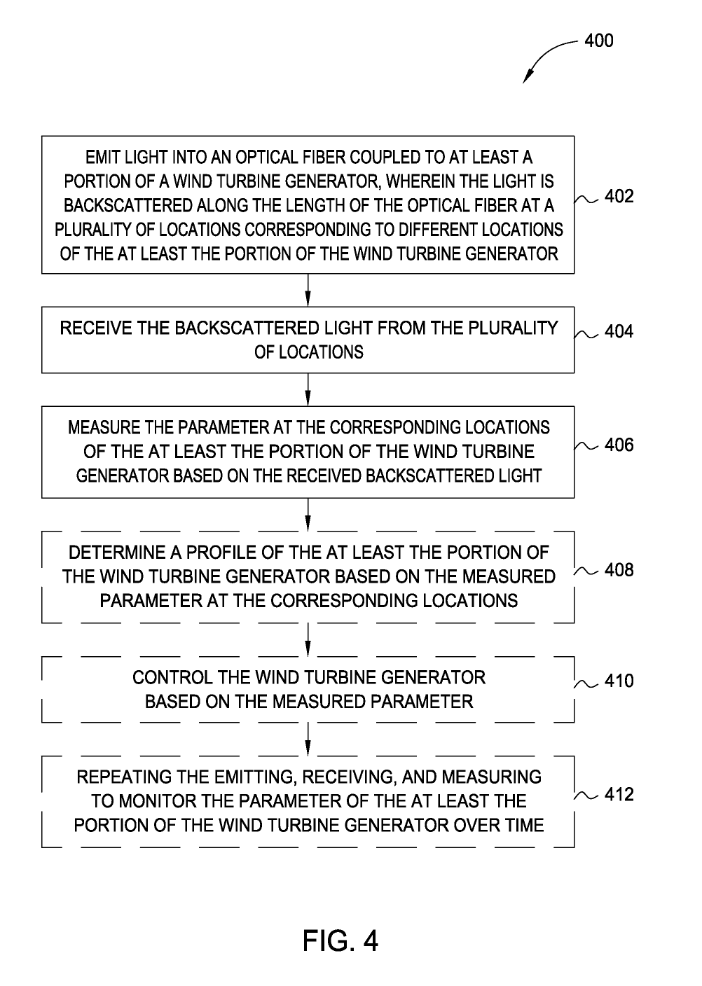

FIG. 4 is a flow diagram of exemplary operations 400 for measuring a parameter of at least a portion of a wind turbine generator 102 using distributed sensing. The portion of the wind turbine generator may be the foundation 205, the tower 202, the nacelle 204, the rotor 206, the blade 208 or any combination thereof. The parameter may be temperature, pressure, strain, or vibration, for example.

The operations 400 may begin, at 402 by emitting light into an optical fiber coupled to the at least the portion of the wind turbine generator, wherein the light is backscattered along the length of the optical fiber at a plurality of locations corresponding to different locations of the at least the portion of the wind turbine generator. A light emitter, such as a laser diode, may emit the light into one end of the optical fiber. For some embodiments, the light emitter may be disposed in the hub 210 of the rotor 206. For other embodiments, the light emitter may be disposed in the blade 208. For some embodiments, the emitted light may be light pulses as described in greater detail below.

At 404, the backscattered light may be received from the plurality of locations. This reception may be performed by an optical receiver, such as a photodetector or a photomultiplier. For some embodiments, the optical receiver may be located in the hub 210 or in the blade 208.

At 406, the parameter may be measured at the corresponding locations of the at least the portion of the wind turbine generator based on the received backscattered light. For some embodiments, the parameter may be measured during operation of the wind turbine generator 102, where the generator is assembled and capable of converting wind energy into electrical energy. In addition, for some embodiments, the parameter may be measured after fabricating at least a portion (e.g., a spar or a shell) of the wind turbine blade 208, but before transporting the blade to a site for the wind turbine generator. The parameter may also be measured during or after transporting the wind turbine blade 208 to a site for the wind turbine generator 102, but before attaching the blade to the hub 210.

This measurement relies on the principle that the parameter can affect the optical fiber (e.g., deforming the optical fiber) and locally change the characteristics of light transmission in the fiber. In other words, temperature, pressure, strain, vibration, or the like may deform the optical fiber such that the Rayleigh scattered signal changes. These changes can be correlated (e.g., through calibration) to measure the parameter absolutely or relatively (i.e., measuring changes in the parameter). Because this backscattering happens all along the length of the optical fiber, the optical fiber may be utilized as a linear sensor for distributed sensing. Unlike reflections from discrete fiber Bragg gratings (FBGs), distributed sensing can be used to measure the parameter in a continuous profile, rather than at discrete points where the FBGs are located.

Distributed sensing may involve two different techniques: Optical Time Domain Reflectometry (OTDR) and Optical Frequency Domain Reflectometry (OFDR). Used to detect Rayleigh backscattered signals based on optical travel time, OTDR is very similar to the time-of-flight measurements used for radar. In OTDR, the light emitter may generate a narrow light pulse for emission into an end of the optical fiber, and the optical receiver may receive the light backscattered along the length of the optical fiber for analysis. Based on the time the backscattered light takes to return to the optical receiver, the location of the measured parameter is determined. In other words, because the speed of light in the optical fiber is constant, the round trip delay dictates the particular location where the light measured at any particular time came from. OFDR is much more complex, but offers an alternative to OTDR.

Irrespective of the technique used, distributed sensing offers a fast, low cost solution for measuring the parameter at myriad locations along substantial lengths of optical fiber. Furthermore, optical fibers have reduced weight, smaller dimensions, and greater immunity to electromagnetic interference than electrical sensors.

For some embodiments, a profile of the at least the portion of the wind turbine generator 102 may be determined at 408 based on the measured parameter at the corresponding locations. For some embodiments, the profile may be a three-dimensional (3-D) profile.

At 410 for some embodiments, the wind turbine generator 102 may be controlled based on the measured parameter. For example, if the strain or vibration is too high on the blade 208 at a particular location, the pitch 318 of the blade may be adjusted, or the nacelle 204 may be yawed. For some embodiments, the parameter may be determined to be outside an operating range. If this occurs, an indication (e.g., a flag) that the parameter is outside the operating range may be transmitted to a control unit, such as the controller 310 or the control station 104. The wind turbine generator 102 may be controlled based on the transmitted indication. For some embodiments, control algorithms may be incorporated with the controller 310 to automatically control the wind turbine generator 102 based on the measured parameter and/or the transmitted indication.

For some embodiments, the emitting, receiving, and measuring may be repeated at 412 to monitor the parameter of the at least the portion of the wind turbine generator 102 over time. In this manner, the health or status of one or more components of the wind turbine generator may be monitored over time in an effort to understand the natural phenomena and mechanical forces acting on various components of a wind turbine generator. Such data may be useful in preventing mechanical failure of wind turbine generators now and designing wind turbine generators to avoid mechanical failure in the future. The emitting, receive, and measuring may be repeated periodically, continuously, or intermittently.

For some embodiments, one or more FBGs may be used in conjunction with the distributed sensing aspect. For example, an FBG may be disposed at a particular location of the optical fiber to reflect a portion of the emitted light at the Bragg wavelength, and the optical receiver may receive the reflected portion of the emitted light. The parameter being measured using distributed sensing or a different parameter of the wind turbine generator corresponding to the particular location may be measured based on the received reflection portion of the light.

With respect to measuring a parameter of the wind turbine blade 208, one or more optical fibers may be embedded in or disposed on an inner or an outer surface of the blade. For example, the optical fibers may be woven into the carbon fiber or glass fiber of a shell or a spar of the blade. The optical fibers may be glued or otherwise affixed to the inner or outer surface of the shell or the spar.

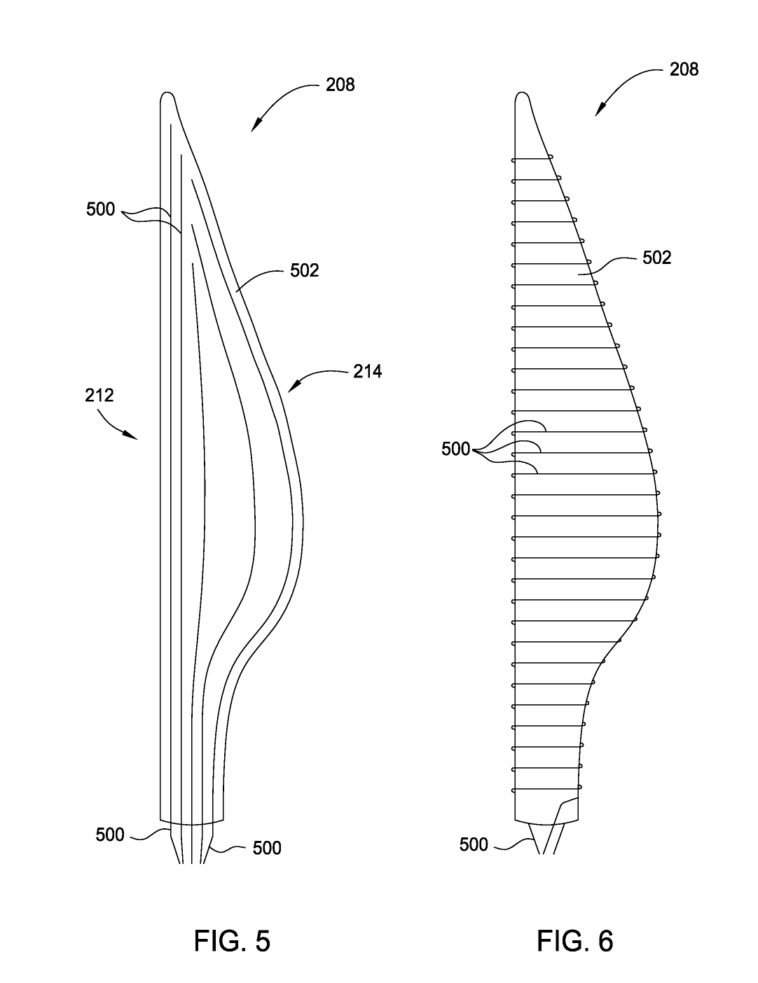

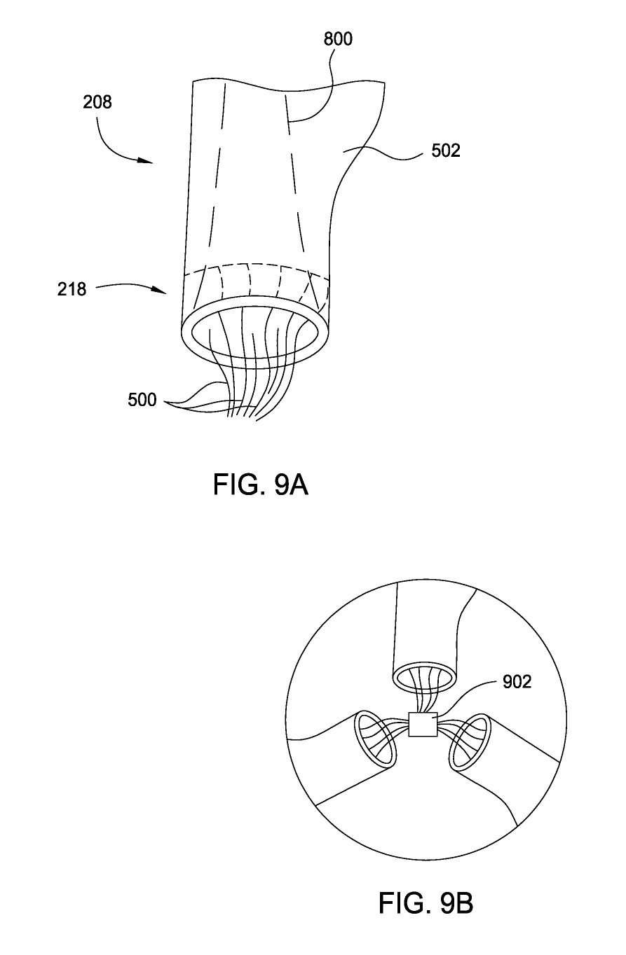

FIG. 5 illustrates a wind turbine blade 208 with one or more optical fibers 500 disposed flat-wise on an outer surface of the blade, or more specifically the outer surface of the shell 502. The optical fibers may be routed on the inner surface of or embedded in the shell with a similar orientation, or any combination of embedded, inner surface disposed, or outer surface disposed optical fibers may be employed. The optical fiber 500 may be disposed at the leading edge 212 and/or at the trailing edge 214. In this manner, icing of the blades may be detected in cold weather conditions. Although shown as separate optical fibers in FIG. 5, the optical fiber 500 may be routed on the outer surface of the shell 502 as one continuous optical fiber. For some embodiments, the optical fibers may be routed from the outer surface of the shell 502, through the thickness of the shell to the inner surface, and out the root 218. In this manner, the optical fibers 500 may be connected to a light emitter and/or an optical receiver disposed in the hub 210, and the root 218 may be bolted to the hub 210 without the optical fibers 500 being in the way. This routing is shown in greater detail in FIGS. 9A and 9B.

FIG. 6 illustrates a wind turbine blade 208 with one or more optical fibers 500 wrapped hoop-wise around the blade, or more specifically around the outer surface of the shell. For other embodiments, the optical fibers 500 may be oriented in this hoop-wise fashion and either affixed to the inner surface of or embedded in the shell 502.

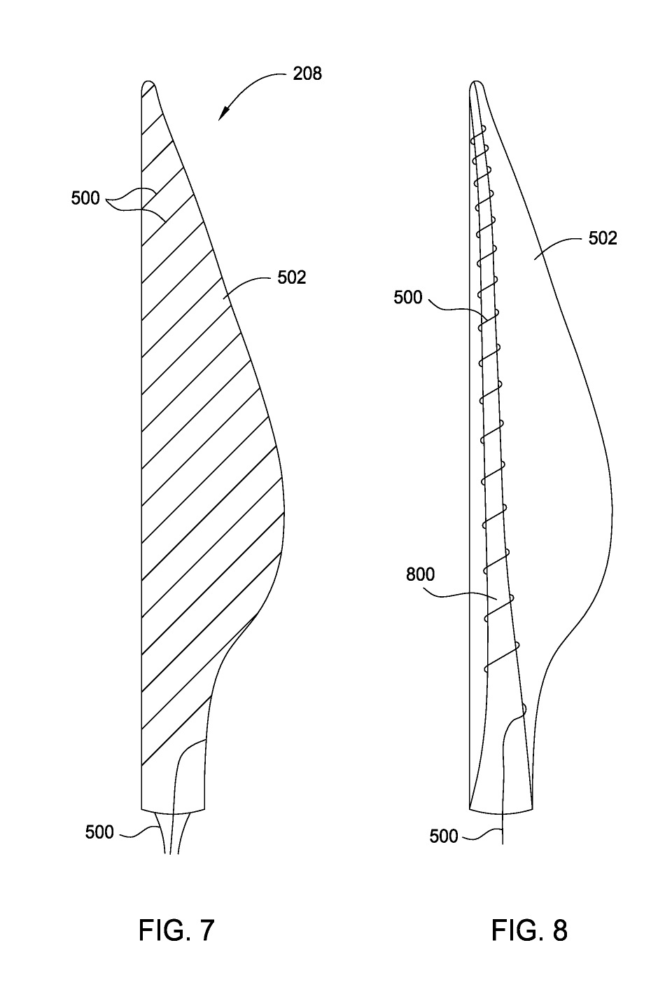

FIG. 7 illustrates a wind turbine blade 208 with one or more optical fibers 500 embedded diagonally in a shell 502 of the blade. The diagonally oriented optical fibers 500 may also be disposed on an inner or an outer surface of the shell 502 for other embodiments. Furthermore, any combination of flat-wise, hoop-wise, or diagonally oriented optical fibers may be used, whether embedded in, disposed on either surface of the shell, or any combination thereof.

FIG. 8 illustrates a wind turbine blade 208 with one or more optical fibers 500 wrapped around a spar 800 of the blade. For other embodiments, the optical fibers may be oriented in any fashion, as described above with respect to the shell or otherwise, whether embedded in, disposed on either surface of the spar 800, or any combination thereof. Although the embodiment in FIG. 8 illustrates a central spar, the optical fibers 500 in other embodiments may be embedded in or disposed on the inner or outer surface of one or more spar caps and/or shear webs internal to the wind turbine blade 208.

FIG. 9A illustrates a plurality of optical fibers 500 routed through the inside diameter of the root 218 of a wind turbine blade 208. From the inside diameter of the root 218, the optical fibers 500 may be affixed to an inner surface of the shell 502 or the spar 800, may be embedded in the shell or spar, or may be routed through the thickness of the shell or the spar for affixing to the outer surface of the shell or spar. In this manner, as shown in the conceptual diagram of FIG. 9B, the optical fibers 500 may be connected to a light emitter and/or an optical receiver 902 disposed in the hub 210, and the root 218 may be bolted to the hub 210 without the optical fibers 500 being in the way.

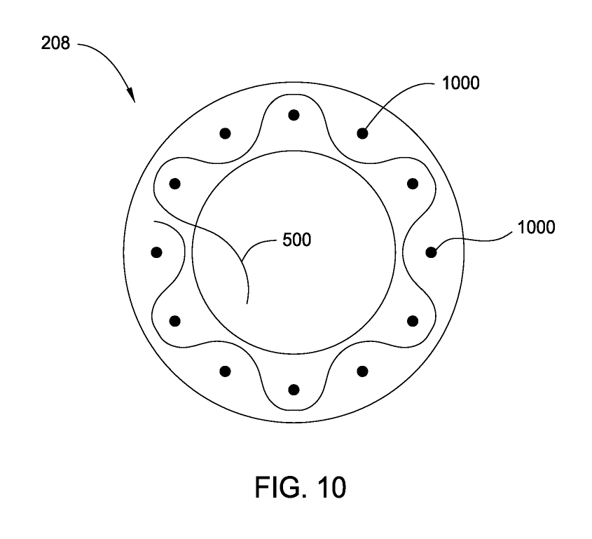

FIG. 10 illustrates an optical fiber 500 woven around bolts 1000 in the root 218 of the wind turbine blade 208. In this manner, the optical fiber 500 may be used to detect spacing problems around the bolts 1000, as well as any potential damage that my occur during (or after) fabrication, transportation, installation, operation, or repair of the wind turbine generator 102.

While the foregoing is directed to embodiments of the present invention, other and further embodiments of the invention may be devised without departing from the basic scope thereof, and the scope thereof is determined by the claims that follow.

What is claimed is:

1. A method of measuring a parameter of at least a portion of a wind turbine generator, the method comprising:
emitting light into an optical fiber coupled to the at least the portion of the wind turbine generator, wherein the light is backscattered along the length of the optical fiber at a plurality of locations corresponding to different locations of the at least the portion of the wind turbine generator;
receiving the backscattered light from the plurality of locations; and
measuring the parameter at the corresponding locations of the at least the portion of the wind turbine generator based on the received backscattered light.

2. The method of claim 1, wherein the parameter comprises at least one of temperature, pressure, strain, or vibration.

3. The method of claim 1, wherein the emitting the light comprises emitting a plurality of light pulses into the optical fiber, wherein the light pulses are backscattered along the length of the optical fiber, wherein the receiving the backscattered light comprises receiving the backscattered light pulses, and wherein the measuring the parameter comprises measuring the parameter at the corresponding locations of the at least the portion of the wind turbine generator based on the received backscattered light pulses according to optical travel timing.

4. The method of claim 1, further comprising determining a profile of the at least the portion of the wind turbine generator based on the measured parameter at the corresponding locations.

5. The method of claim 4, wherein the profile is a three-dimensional (3-D) profile.

6. The method of claim 1, further comprising repeating the emitting, the receiving, and the measuring to monitor the parameter of the at least the portion of the wind turbine generator over time.

7. The method of claim 6, wherein the repeating comprises periodically or continuously repeating the emitting, the receiving, and the measuring.

8. The method of claim 1, further comprising:
determining that the parameter is outside an operating range; and
transmitting, to a control unit, an indication that the parameter is outside the operating range.

9. The method of claim 8, further comprising controlling the wind turbine generator based on the indication.

10. The method of claim 1, wherein the at least the portion of the wind turbine generator comprises at least one of a rotor, a nacelle, a tower, or a foundation for the wind turbine generator.

11. The method of claim 1, wherein the at least the portion of the wind turbine generator comprises a wind turbine blade for the wind turbine generator.

12. The method of claim 11, wherein the optical fiber is woven into carbon fiber or glass fiber of the wind turbine blade.

13. The method of claim 11, wherein the optical fiber is woven around bolts in a root of the wind turbine blade.

14. The method of claim 11, wherein the optical fiber is disposed around a root, around a spar, at a spar cap, at a shear web, in a shell, at the leading edge, or at the trailing edge of the wind turbine blade.

15. The method of claim 11, wherein the optical fiber is disposed on an outer or an inner surface of the wind turbine blade.

16. The method of claim 11, wherein the optical fiber is wrapped around the wind turbine blade.

17. The method of claim 11, wherein the wind turbine blade is coupled to a hub, wherein the emitting the light comprises emitting the light into an end of the optical fiber, and wherein the end of the optical fiber is disposed in the hub.

18. The method of claim 11, wherein measuring the parameter comprises measuring the parameter after fabricating at least a portion of the wind turbine blade, but before transporting the blade to a site for the wind turbine generator.

19. The method of claim 11, wherein measuring the parameter comprises measuring the parameter during or after transporting the wind turbine blade to a site for the wind turbine generator, but before attaching the blade to a hub of the wind turbine generator.

20. The method of claim 1, further comprising:
using a fiber Bragg grating (FBG) disposed at a particular location of the optical fiber to reflect a portion of the emitted light;
receiving the reflected portion of the emitted light; and
measuring the parameter or another parameter of the wind turbine blade corresponding to the particular location based on the received reflected portion of the light.

21. A wind turbine generator, comprising:
a tower;
a nacelle coupled to the tower;
a rotor coupled to the nacelle, comprising:
a hub; and
at least one blade coupled to the hub;
an optical fiber coupled to at least one of the tower, the nacelle, or the blade and configured such that light emitted into an end of the optical fiber is backscattered along the length of the optical fiber at a plurality of locations corresponding to different locations of the tower, the nacelle, or the blade and is received at the end of the optical fiber from the plurality of locations; and
at least one processor configured to measure a parameter of the at least one of the tower, the nacelle, or the blade at the corresponding locations based on the received backscattered light.

22. The wind turbine generator of claim 21, wherein the parameter comprises at least one of temperature, pressure, strain, or vibration.

23. The wind turbine generator of claim 21, further comprising a light emitter for emitting a plurality of light pulses into the end of the optical fiber, wherein the light pulses are backscattered along the length of the optical fiber, wherein the backscattered light pulses are received at the end of the optical fiber, and wherein the at least one processor is configured to measure the parameter at the corresponding locations of the at least one of the tower, the nacelle, or the blade based on the received backscattered light pulses according to optical travel timing.

24. The wind turbine generator of claim 21, further comprising a control unit, wherein the at least one processor is configured to determine that the parameter is outside an operating range and to transmit to the control unit, an indication that the parameter is outside the operating range.

25. The wind turbine generator of claim 24, wherein the control unit is configured to control the wind turbine generator based on the indication.

26. The wind turbine generator of claim 21, wherein the optical fiber is coupled to the blade, wherein the blade comprises carbon fiber or glass fiber, and wherein the optical fiber is woven into the carbon fiber or the glass fiber of the blade.

27. The wind turbine generator of claim 21, wherein the optical fiber is coupled to the blade and wherein the optical fiber is woven around bolts in a root of the blade.

28. The wind turbine generator of claim 21, wherein the optical fiber is disposed around a root, around a spar, at a spar cap, at a shear web, in a shell, at the leading edge, or at the trailing edge of the blade.

29. The wind turbine generator of claim 21, wherein the optical fiber is disposed on an outer or an inner surface of the blade.

30. The wind turbine generator of claim 21, wherein the optical fiber is wrapped around the blade.

31. The wind turbine generator of claim 21, further comprising a light emitter for emitting the light into the end of the optical fiber, wherein the optical fiber is coupled to the blade and wherein the light emitter and the end of the optical fiber are disposed in the hub.

32. The wind turbine generator of claim 21, further comprising a fiber Bragg grating (FBG) disposed at a particular location of the optical fiber to reflect a portion of the emitted light such that the reflected portion of the emitted light is received at the end of the optical fiber, wherein the at least one processor is configured to measure the parameter or another parameter of the at least one of the tower, the nacelle, or the blade corresponding to the particular location based on the received reflected portion of the light.

33. A system comprising:
a plurality of wind turbine generators, wherein at least one of the wind turbine generators comprises:
a tower;
a nacelle coupled to the tower;
a rotor coupled to the nacelle, comprising:
a hub; and
at least one blade coupled to the hub;
an optical fiber coupled to at least one of the tower, the nacelle, or the blade and configured such that light emitted into an end of the optical fiber is backscattered along the length of the optical fiber at a plurality of locations corresponding to different locations of the tower, the nacelle, or the blade and is received at the end of the optical fiber from the plurality of locations; and
at least one processor configured to measure a parameter of the at least one of the tower, the nacelle, or the blade at the corresponding locations based on the received backscattered light; and
a control station for receiving the measured parameter from the at least one of the wind turbine generators.

34. The system of claim 33, wherein the parameter comprises at least one of temperature, pressure, strain, or vibration.

35. The system of claim 33, further comprising a remote station, wherein the control station is configured to determine whether the parameter is outside an operating range and to transmit, to the remote station, an indication that the parameter is outside the operating range.

36. The system of claim 33, wherein the control station is configured to control the wind turbine generator based on the measured parameter.

37. The system of claim 33, wherein the control station is configured to monitor the health of the at least one of the tower, the nacelle, or the blade of the at least one of the wind turbine generators based on measurements of the parameter over time.

38. A blade for a wind turbine generator, comprising:
a shell; and
an optical fiber coupled to or internal to the shell and configured such that light emitted into an end of the optical fiber is backscattered along the length of the optical fiber at a plurality of locations corresponding to different locations of the blade and is received at the end of the optical fiber for measuring a parameter of the blade at the corresponding locations based on the received backscattered light.

39. The blade of claim 38, wherein the optical fiber is disposed on an inner or an outer surface of the shell or wrapped around the shell.

40. The blade of claim 38, further comprising a spar, wherein the shell is disposed around the spar and wherein the optical fiber is coupled to at least one of the shell or the spar.

41. The blade of claim 40, wherein the optical fiber is disposed on an outer surface of the spar or wrapped around the spar.

42. The blade of claim 38, wherein the optical fiber is woven around bolts in a root of the blade.

43. The blade of claim 38, wherein the optical fiber is disposed at a leading edge of the blade or disposed at a trailing edge of the blade.

44. The blade of claim 38, wherein the optical fiber is embedded in the shell.
